(19) United States
(12) Patent Application Publication
(10) Pub. No.: US 2012/0224378 A1
(43) Pub. Date: Sep. 6, 2012

(54) WAVELENGTH CONVERTING MEMBER AND LIGHT SOURCE DEVICE

(75) Inventors: Teruo KOIKE, Tokyo (JP); Ji-Hao Liang, Tokyo (JP)

(73) Assignee: STANLEY ELECTRIC CO., LTD., Tokyo (JP)

(21) Appl. No.: 13/409,676

(22) Filed: Mar. 1, 2012

(30) Foreign Application Priority Data
Mar. 2, 2011 (JP) 2011-045309

(51) Int. Cl. F21V 13/14; F21V 13/02

(52) U.S. Cl. 362/259; 362/332; 362/327

(57) ABSTRACT

A wavelength converting member radiates light having a wavelength different from that of laser light introduced into the wavelength converting member. The wavelength converting member has a phosphor layer that contains a phosphor therein. The phosphor layer has a laser light incidence surface capable of receiving the laser light. The wavelength converting member also has a high-refractive layer that is bonded to an opposite surface of the phosphor layer to the laser light incidence surface thereof. A refractive index of the high-refractive layer is higher than a refractive index of the phosphor layer. The high-refractive layer has concaves on at least either the bonding surface where the high-refractive layer is bonded to the phosphor layer or a light extraction surface that is opposite the bonding surface.

### BACKGROUND OF THE INVENTION

The present invention relates to a light source device using a semiconductor laser.

Semiconductor lasers have an electricity-light conversion efficiency higher than that of light-emitting diodes and can ensure a high output. Accordingly, they are expected to find use as light sources for projectors or high-luminance white light sources such as automobile headlights. When a semiconductor laser is used to obtain white light, a blue semiconductor laser is combined with a wavelength converting member including a phosphor. A phosphor layer is irradiated with a blue laser light, wavelength conversion is performed by the phosphor to a longer wavelength range, and the resulting wavelength-converted light is mixed with light that has been transmitted, without wavelength conversion, through the phosphor layer, thereby producing white light.

Japanese Patent No. 4,054,594 or Japanese Patent Application Publication (Kokai) No. 2003-295319 discloses a light source device that has a laser diode to emit a laser light. The laser light is converged on a phosphor and incoherent spontaneously emitted light is obtained from the phosphor. Japanese Patent Application Publication No. 2010-24278 discloses a light-emitting device using the so-called phosphor ceramic, which is a sintered phosphor, as a wavelength converting member. Japanese Patent No. 4,158,012 or Japanese Patent Application Publication No. 2003-258308 discloses a wavelength converting member constituted by the so-called phosphor glass, which is obtained by dispersing a phosphor in glass.

### SUMMARY OF THE INVENTION

A material prepared by dispersing phosphor particles in a resin binder is a typical wavelength converting member containing a phosphor. However, the resin binder is burned out when a phosphor layer using a resin binder is irradiated with a high-output laser light. To avoid this problem, when a high-output laser light source is used, it is preferred that a phosphor ceramic or phosphor glass, which uses inorganic materials as a matrix, such as described in Japanese Patent Application Publication No. 2010-24278 and Japanese Patent No. 4,158,012, be used as the wavelength converting member.

Since laser light has a high output and a small spot size, the light energy density is high. Therefore, the laser light can damage human eyes. When light from the usual semiconductor laser, which has a small spot size, is focused to a fine spot on a retina, it induces local heat emission on the retina. In the case of a visible light laser, there is also a risk of causing a biochemical reaction with the eye or retina. As such, the retina can be damaged even when the total light power is small.

FIG. 1 of the accompanying drawings shows the configuration of a light source device 100 that includes a laser light source 110 and a wavelength converting member 120 made from phosphor glass or phosphor ceramic. Laser light emitted from the laser light source 110 is radiated on the wavelength converting member 120. White light obtained by mixing of wavelength-converted yellow light YL and blue light BL that has been transmitted, without wavelength conversion, by the wavelength converting member 120 is emitted from the light extraction surface of the wavelength converting member 120.

When the wavelength converting member 120 is made from phosphor glass, the difference in refractive index between the phosphor particles and the glass is as small as about 0.3 to 0.35. Therefore, light scattering is not facilitated and the ratio (or amount) of light component that propagates straight through the wavelength converting member 120 increases. Accordingly, coherent light with matched wavefronts is emitted from the light extraction surface. When such light is focused by an optical system, the focused light can produce a spot size at the laser emission aperture which can be dangerous for human eyes.

If the wavelength converting member is made from a phosphor ceramic, a refractive index variation at the phosphor grain boundaries is small and the laser light propagates in the wavelength converting member 120, without undergoing significant scattering. Consequently, a problem of safety to eyes arises in the same manner as in the case of phosphor glass.

With the configuration of the light source device 100 shown in FIG. 1, it is difficult to ensure perfect mixing of the yellow light YL and blue light BL. Specifically, the yellow light YL radiated from the phosphor is radiated in all directions due to diffraction, whereas the blue light BL that has been transmitted by the wavelength converting member 120 is radiated only within a range corresponding to the divergence angle of the laser light. Thus, the light extracted from the wavelength converting member 120 has different colors in the center and on the circumference.

It is an object of the present invention to provide a wavelength converting member that can ensure safety to human eyes and improve color mixing ability of emitted colors.

Another object of the present invention is to provide a light source device using such wavelength converting member.

According to one aspect of the present invention, there is provided a wavelength converting member into which laser light is introduced and which radiates light having a wavelength different from a wavelength of the laser light. The wavelength converting member includes a phosphor layer that has a laser light incidence surface capable of introducing (receiving) the laser light. The phosphor layer contains a phosphor in the layer. The wavelength converting member also includes a high-refractive layer that is bonded to an opposite surface of the phosphor layer to the laser light incidence surface thereof. The high-refractive layer has a refractive index higher than a refractive index of the phosphor layer. The high-refractive layer has peaks and valleys (or concaves) on at least either the bonding surface where the high-refractive layer is bonded to the phosphor layer or a light extraction surface that is opposite the bonding surface.

According to another aspect of the present invention, there is provided a light source device that has the above-described wavelength converting member. The light source device also includes a semiconductor laser adapted to irradiate the laser light incidence surface with laser light.

With the wavelength converting member and light source device in accordance with the present invention, it is possible to ensure safety to human eyes and improve color mixing ability of emitted colors.

These and other objects, aspects and advantages of the present invention will become apparent to those skilled in the art from the following detailed description when read and understood in conjunction with the appended claims and drawings.

### BRIEF DESCRIPTION OF THE DRAWINGS

FIG. 1 illustrates the schematic configuration of a light source device including a wavelength converting member constituted by phosphor glass or phosphor ceramic;

FIG. 2 illustrates the configuration of a light source device according to Embodiment 1 of the present invention;

FIG. 3A illustrates light scattering at the light extraction surface of a high-refractive layer in the device shown in FIG. 2;

FIG. 3B illustrates light diffraction at the light extraction surface of the high-refractive layer in the device shown in FIG. 2;

FIGS. 4A to 4D is a series of views to illustrate a method of manufacturing a wavelength converting member according to Embodiment 1 of the present invention;

FIG. 5 shows the configuration of a light source device including a wavelength converting member according to Embodiment 2 of the present invention;

FIGS. 6A to 6D is a series of views to illustrate a method of manufacturing a wavelength converting member according to Embodiment 2 of the present invention; and

FIGS. 7A to 7D illustrate configurations of wavelength converting members according to modified embodiments of the present invention, respectively.

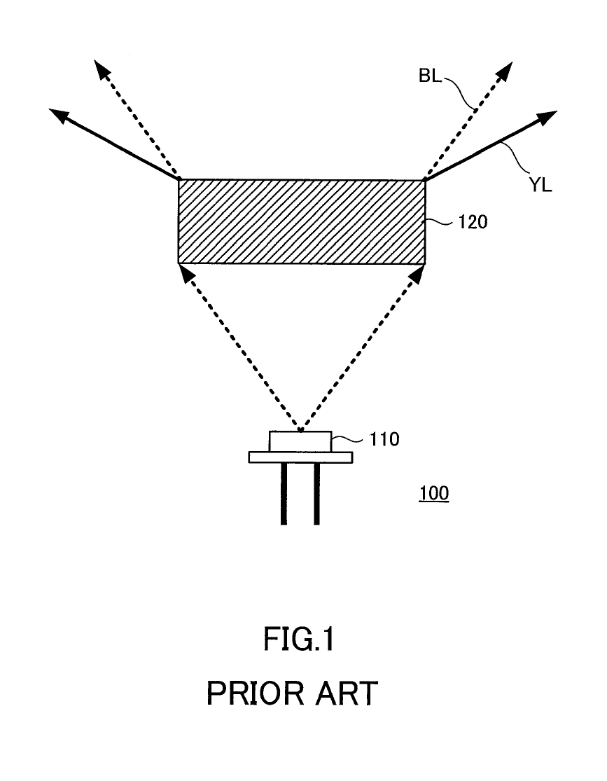

### DETAILED DESCRIPTION OF THE INVENTION

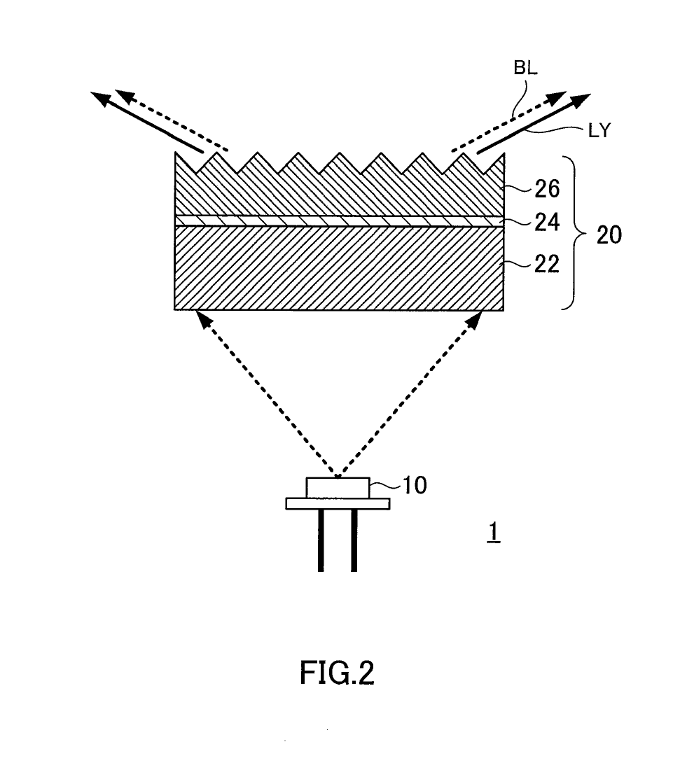

Embodiments of the present invention will be described below with reference to FIG. 2 to FIG. 7D. In the drawings, substantially identical or equivalent elements and components are assigned with same reference numerals and symbols.

### Embodiment 1

Referring to FIG. 2, the configuration of a light source device 1 according to a first embodiment of the present invention will be described. The light source device 1 includes a semiconductor laser 10 that is adapted to emit a laser light and a wavelength converting member 20 that receives the laser light and radiates light with a wavelength longer than that of the laser light.

The semiconductor laser 10 is a light-emitting element including, for example, a GaN-based nitride semiconductor layer. This semiconductor layer possesses a multiple quantum well structure and radiates blue light with a wavelength of about 450 nm. It should be noted that the light emission wavelength, material, and layer structure of the semiconductor laser 10 are not limited to those mentioned above and may be suitably selected depending on its application and/or given conditions.

The wavelength converting member 20 receives the laser light emitted from the semiconductor laser 10. The wavelength converting member 20 is a layered body in which a phosphor layer 22, an adhesive layer 24, and a high-refractive layer 26 are laminated. The wavelength converting member 20 is disposed so that the phosphor layer 22 faces the semiconductor laser 10, and the surface of the light scattering layer 26 is a light extraction surface (light take-out surface). It should be noted that an optical system such as a lens may be provided between the semiconductor laser 10 and the wavelength converting member 20, and the wavelength converting member 20 may be irradiated with the laser light converged by the optical system.

The phosphor layer 22 is made from a material having heat resistance sufficient to prevent the material from being burned out by the laser light emitted from the semiconductor laser 10, for example, from phosphor glass. In the phosphor glass, a phosphor is dispersed in glass. More specifically, the phosphor glass is a sintered body of a glass powder and a phosphor powder. Examples of the preferred glass include B₂O₃-SiO₂ glass and BaO⁻B₂O₃-SiO₂ glass. The phosphor is a YAG:Ce phosphor that absorbs the blue light with a wavelength of about 450 nm that is emitted from the semiconductor laser 10 and converts the absorbed light, for example, into yellow light having an emission peak close to a wavelength of 560 nm. The yellow light obtained by wavelength conversion by the phosphor is mixed with the blue light that has been transmitted, without wavelength conversion, by the phosphor layer 22, thereby producing (obtaining) white light at the light extraction surface of the wavelength converting member 20. The refractive index of phosphor glass is between about 1.45 and about 1.65, and the refractive index difference between the phosphor glass and air (refractive index is 1) air is small. Thermal conductivity of phosphor glass is extremely small (1 W/m·K). Therefore, when the wavelength converting member is made from phosphor glass alone, the radiation angle range of the blue light that has been radiated upon transmission by the phosphor glass is comparatively small and wavefront fluctuations are also small. As such, color unevenness occurs and safety to eye is difficult to ensure. Further, the heat generated from the phosphor cannot be efficiently dissipated to the outside and temperature rises excessively. These problems are resolved by laminating a high-refractive layer 26 on the phosphor layer 22 (will be described below). It should be noted that the phosphor layer 22 may be made from a phosphor ceramic, which is a phosphor sintered body. A phosphor ceramic can be obtained, for example, by mixing an oxide such as yttrium oxide, aluminum oxide, and cerium oxide with an alcohol solvent to produce a granulated powder, molding the powder, cleaning the powder (degreasing the powder, removing a binder), and then baking it under a vacuum atmosphere.

The adhesive layer 24 includes a bonding material for bonding the phosphor layer 22 and the high-refractive layer 26 together. The adhesive layer 24 is made from, for example, SOG (spin on glass). When SOG is used for the adhesive layer 24, the difference in refractive index between the adhesive layer 24 and the phosphor glass of the phosphor layer 22 is decreased. Therefore, the adhesive layer 24 does not become a light reflecting surface.

The high-refractive layer 26 is made from a material that has a refractive index higher than that of the phosphor glass of the phosphor layer 22 and can transmit light emitted from the semiconductor laser 10. The difference in refractive index between the high-refractive layer 26 and air is preferably equal to or greater than 1. Nitride semiconductor crystals such as GaN, AlGaN, and InGaN are preferred materials for the high-refractive layer 26. These nitride semiconductor crystals have a refractive index of about 2.5 and transmit light with a wavelength of equal to or greater than 400 nm. The thickness of the high-refractive layer 26 is preferably between 0.5 μm and 20 μm. A plurality of protrusions for enhancing or facilitating light scattering and diffraction are formed over the entire surface of the high-refractive layer 26 that is the light extraction surface, and this surface of the high-refractive layer 26 is a concave surface. Thus, the surface of the high-refractive layer 26 is a surface with a light-scattering and diffractive structure constituted by a plurality of protrusions (or peaks and valleys). It is preferred that the protrusions be of random sizes and have a hexagonal pyramidal shape derived from the crystal structure of the nitride semiconductor crystals. Such protrusions are called microcones and can be easily formed by wet etching the C-surface of a nitride semiconductor crystal with an alkali solution. In order to obtain a necessary and sufficient light scattering effect, it is preferred that the size (diameter) and height of the bottom surface of the hexagonal pyramidal protrusion be between 90 nm and 5 μm. These dimensions can be controlled by the etching time and etchant temperature. When a red laser is used as the semiconductor laser 10, a phosphide semiconductor crystal such as GaP may be used as the material of the high-refractive layer 26. GaP has a very high refractive index of 3.2 and can transmit red laser light. Similar to nitride semiconductor crystals, pyramidal protrusions can be formed by wet etching on the phosphide semiconductor crystals. Therefore, surface roughening can be achieved.

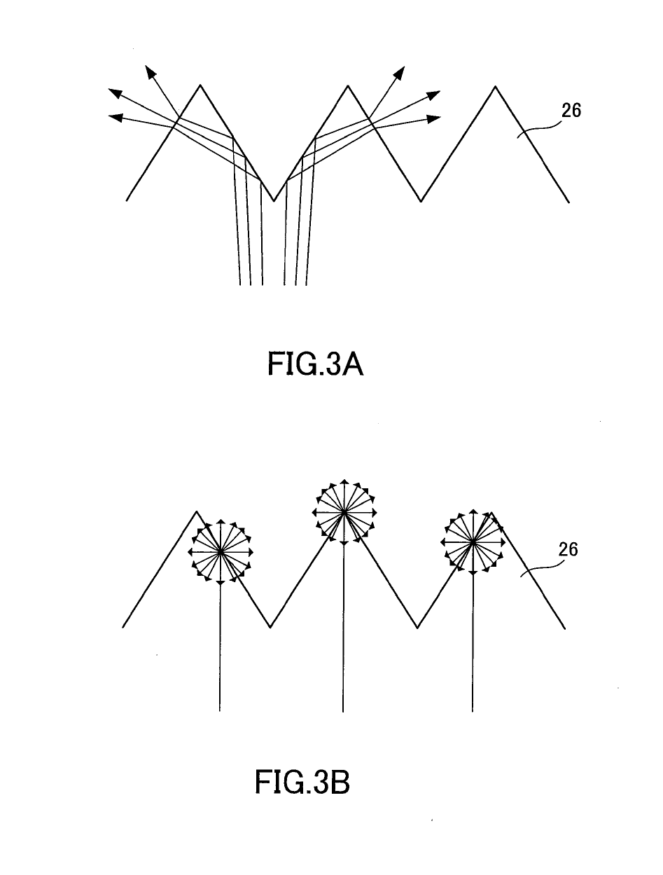

FIG. 3A illustrates scattering of light emitted from the light extraction surface of the surface-roughened high-refractive layer 26, and FIG. 3B illustrates diffraction of the light emitted from the light extraction surface of the same layer 26. The light introduced in the high-refractive layer 26 undergoes scattering and diffraction at the roughened light extraction surface and is emitted to the atmosphere.

FIG. 3A shows light that is emitted while being scattered at the surface of the high-refractive layer 26, which is the light extraction surface. The light from the semiconductor laser 10 is introduced in the wavelength converting member 20, for example, in the form of scattered light or converged light that has been converged by an optical system. In this case, the light extraction surface of the high-refractive layer 26 is irradiated with the light from various directions and the light is radiated from the protrusions into the atmosphere in various directions. Since the difference in refractive index between the high-refractive layer 26 and the air is comparatively large, the radiation angle range of the light radiated into the atmosphere can be increased. Thus, the high-refractive layer 26 has a high refractive index and therefore light scattering is effectively induced. The enhancement of light scattering increases safety to the eyes and also improves the mixing ability of emitted colors. Thus, with the light source device 1 of this embodiment, the radiation angle range of the blue light radiated from the light extraction surface of the wavelength converting member 20 is expanded. Therefore, the yellow light YL and blue light BL can be mixed almost perfectly, as shown in FIG. 2.

FIG. 3B shows the light emitted upon diffraction at the surface of the high-refractive layer 26, which is the light extraction surface. When the diameter and height of protrusions formed on the surface of the high-refractive layer 26 are not more than about 10 times the wavelength of the light inside the high-refractive layer 26, the light is diffracted on collision with the protrusions, thereby generating new wavefronts. The light diffracted on the protrusions cannot be restored to the spot diameter of the laser light emitted from the semiconductor laser 10 by any optical system. In other words, the light beam spot size is expanded to the size of the light extraction surface of the wavelength converting member 20. When the light beam spot size is sufficiently large, danger to the human eyes can be eliminated and eye safety is ensured.

When the light from the semiconductor laser 10 is introduced in the wavelength converting member 20 in the form of a parallel light, it is preferred that the size of protrusions on the surface of the high-refractive layer 26 be comparatively small. If this configuration is employed, light scattering on the light extraction surface is inhibited and the diffraction becomes predominant. Because the microcones are hexagonal pyramidal protrusions with a specific crystal plane(s) being exposed, light emission may be collected or concentrated in a specific direction if the size of the microcones is large and a parallel light is introduced. This problem can be avoided when the size of the microcones is reduced and diffraction becomes predominant on the light extraction surface. More specifically, it is preferred that the diameter and height of the bottom surface of the protrusions be set within a range of 0.5 times to 5 times the laser wavelength inside the high-refractive layer 26. For example, when a GaN blue laser is used and the high-refractive layer 26 is made from GaN, it is preferred that the protrusion size be between 90 nm and 500 nm, more preferably between 150 nm and 300 nm.

Since the difference in refractive index between the high-refractive layer 26 and the air is large, the share of light that undergoes multiple reflections at the interface between the high-refractive layer 26 and the air is large. As a result, the blue light and yellow light can be uniformly mixed inside the wavelength converting member 20 and white light that is free from color unevenness can be obtained. Thus, the wavelength converting member 20 also functions as a light mixer. By providing a large number of hexagonal pyramidal protrusions on the surface of the high-refractive layer 26, a light extraction efficiency substantially close to the theoretic one can be achieved. The layered configuration in which a layer with a low refractive index (phosphor layer 22) is arranged on the laser light incidence surface and a layer with a high refractive index (high-refractive layer 26) is arranged on the light extraction surface also contributes to the increased light extraction efficiency.

Since the thermal conductivity of the nitride semiconductor of the high-refractive layer 26 is between 150 W/m·K and 250 W/m·K, that is, comparatively good, and a plurality of protrusions are formed on the surface, the heat generated in the phosphor layer 22 is effectively dissipated into the atmosphere. When the hexagonal pyramidal protrusions are densely formed on the surface of the high-refractive layer 26, the surface area becomes about twice as large as that of a plane.

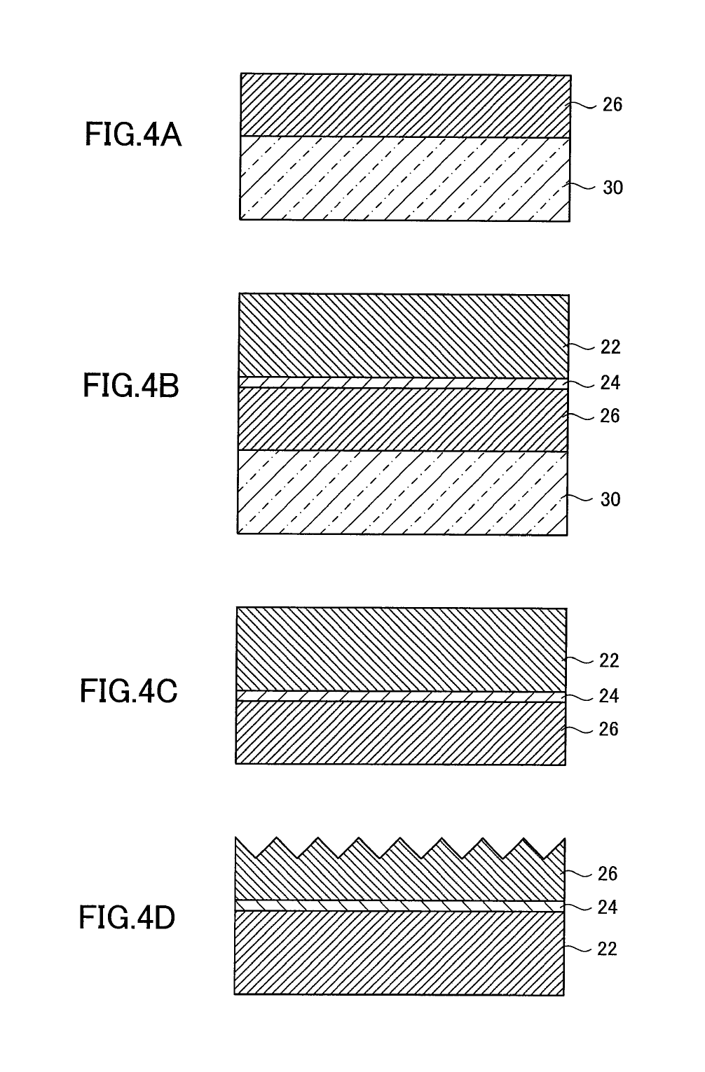

Now a method of manufacturing the wavelength converting member 20 having the above-described configuration is described below with reference to FIGS. 4A to 4D.

First, a C-plane sapphire substrate 30 is prepared on which a GaN-based nitride semiconductor crystal (or similar nitride semiconductor crystal) can be grown. Then, the high-refractive layer 26 with a thickness of about 10 μm made from GaN is formed on the substrate 10 by metal organic chemical vapor deposition (MOCVD) (FIG. 4A).

Phosphor glass that will constitute the phosphor layer 22 is prepared. The phosphor glass is a sintered body of a glass powder and a phosphor powder. An SOG solvent that is the material of the adhesive layer 24 is coated on the surface of the high-refractive layer 26 by a spin coating method. The SOG solvent is prepared by dissolving silanol (Si(OH)₄) in alcohol. The phosphor layer 22 is brought into contact with the high-refractive layer 26 and a pressure is applied thereto. The pressing pressure is, for example, 5 kg/cm² and the pressing time is for example 10 minutes. Then, the phosphor layer 22 and the high-refractive layer 26 that are held together are subjected to a heat treatment for 30 minutes at 450° C. such that the SOG solvent component is evaporated, and the silanol is dehydration polymerized. As a result, the phosphor layer 22 and the high-refractive layer 26 are bonded together by the adhesive layer 24 (FIG. 4B).

Subsequently the sapphire substrate 30 is peeled off by a laser lift-off method. An excimer laser may be used as the laser light source. The laser light irradiating the rear surface side of the sapphire substrate 30 reaches the high-refractive layer 26 and decomposes GaN in the vicinity of the interface with the sapphire substrate 30 into metallic Ga and N₂ gas. As a result, voids are formed between the sapphire substrate 30 and the high-refractive layer 26, and the sapphire substrate 30 is peeled off from the high-refractive layer 26. Where the sapphire substrate 30 is peeled off, the surface of the high-refractive layer 26 is exposed (FIG. 4C).

The surface of the high-refractive layer 26 that has been exposed by peeling off the sapphire substrate 30 is etched by TMAH (tetramethylammonia solution) or the like, and a plurality of hexagonal pyramidal protrusions (microcones) derived from the crystal structure of GaN are formed on the surface of the high-refractive layer 26 (FIG. 4D). The wavelength converting member 20 is produced by the above-described steps.

As understood from the foregoing description, the wavelength converting member 20 of this embodiment has the phosphor layer 22 disposed on the semiconductor layer side and the high-refractive layer 26 that is bonded to the surface which is opposite the laser light incidence surface of the phosphor layer 22. The high-refractive layer 26 has a refractive index higher than that of the phosphor layer 22. A large number of hexagonal pyramidal protrusions are formed on the light extraction surface of the high-refractive layer 26. Because of such a configuration of the wavelength converting member 20, a light scattering-diffraction structure is provided on the light extraction surface, and the laser light that has been transmitted by the phosphor layer 22 undergoes scattering and diffraction at the light extraction surface of the high-refractive layer 26 and is emitted into the atmosphere. Since the difference in refractive index between the high-refractive layer 26 and the air is comparatively large, the degree of the scattering and diffraction is also large and large fluctuations can be imparted to the wavefront of the laser light. Thus, with the wavelength converting member 20 of the first embodiment, the laser light can be taken out as incoherent light, and safety to the eyes and color mixing ability are improved. By making the high-refractive layer 26 from a material with a thermal conductivity higher than that of the phosphor layer 22, the heat generated during wavelength conversion of the laser light by the phosphor can be effectively dissipated or released into the atmosphere.

### Embodiment 2

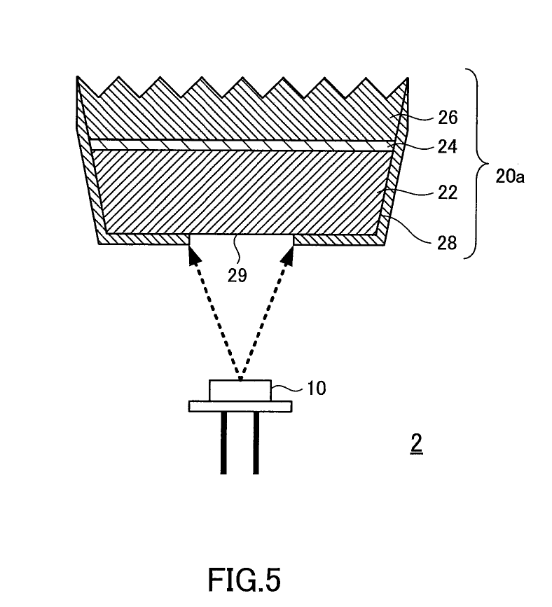

FIG. 5 shows the configuration of a light source device 2 according to Embodiment 2 of the present invention. The configuration of the wavelength converting member 20a of the light source device 2 is different from that of Embodiment 1. A wavelength converting member 20a has a light reflecting film 28 on part of the laser light incidence surface and the surface excluding the entire light extraction surface. Thus, the light reflecting film 28 covers the side surface of the wavelength converting member 20a and part of the bottom surface of the phosphor layer 22, which is the laser light incidence surface. The portion of the laser light incidence surface where the light reflecting film 28 has not been formed is a laser light incidence port or opening 29 for introducing (or receiving) the laser light into the wavelength converting member 20a. The light reflecting film 28 is made from a metal having light reflecting ability, for example, from a multilayer film obtained by successive lamination of Ag/Ti/Pt/Au. Where the surface of the wavelength converting member 20a is covered by the light reflecting film 28, the light which would have otherwise exited from the side surface of the wavelength converting member 20a is reflected by the light reflecting film 28 inward of the wavelength converting member 20a. This increases the quantity of light that is extracted from the light extraction surface and improves the light extraction efficiency. Since light scattering and diffraction are unlikely to occur on the side surface of the wavelength converting member 20a, it is dangerous to allow the light to be emitted to the outside from the side surface of the wavelength converting member 20a. By providing the light reflecting film 28 on the surface of the wavelength converting member 20a, this embodiment is able to prevent such dangerous emission of light and ensure safety to the eyes.

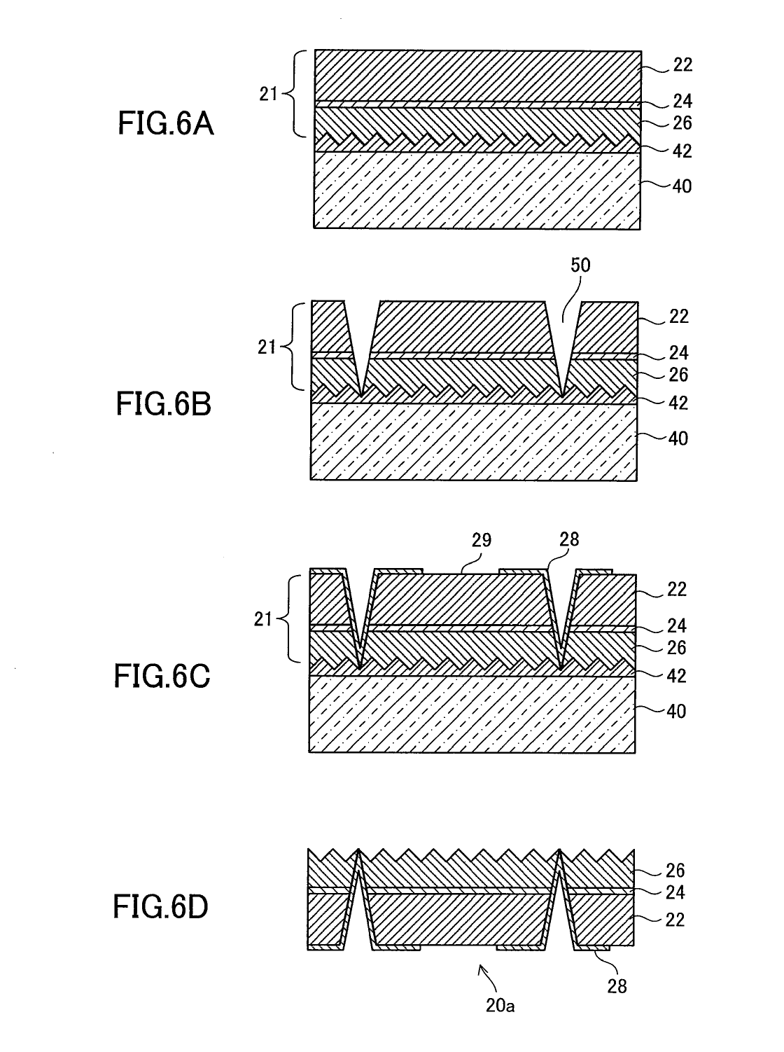

FIGS. 6A to 6D illustrate a method of manufacturing the wavelength converting member 20a according to Embodiment 2. A wafer 21 is prepared in which the high-refractive layer 26 is laminated on the phosphor layer 22 obtained by the steps illustrated in FIGS. 4A to 4D. In the meantime, a support substrate 40 for temporarily supporting the wafer 21 is provided. For example, a sapphire substrate may be used as the support substrate 40, provided that the sapphire substrate has a mechanical strength sufficient to prevent fracture in a wafer dicing process (will be described later) and transmissivity with respect to UV radiation. The wafer 21 is then brought into contact to (or bonded to) the support substrate 40 by using an adhesive sheet 42, so that the surface of the high-refractive layer 26 having a plurality of protrusions formed thereon becomes a joining surface. The adhesive sheet 42 is a UV-peelable adhesive sheet that can be peeled off when irradiated with UV radiation of predetermined energy (FIG. 6A).

The wafer 21 is then divided along predetermined dividing lines by a dicing method or a laser scribing method. Division grooves 50 are formed to a depth such that the grooves reach the adhesive sheet 42, but do not reach the support substrate 40. It is preferred that the division grooves 50 have a V-like shape such that the groove width decreases gradually downward. Thus, it is preferred that the division grooves 50 be formed such that the divided pieces have a tapered shape (FIG. 6B).

A resist mask (not shown in the figure) is then formed that covers a portion corresponding to the laser incident port 29 of the phosphor layer 22, and Ag (thickness 250 nm), Ti (thickness 100 nm), Pt (thickness 200 nm) and Au (thickness 200 nm) are successively deposited by a vapor deposition method or the like so as to cover the upper surface of the wafer 20 and the side surface exposed by the formation of the division grooves 50, and the light reflecting film 28 is thus formed. The above-mentioned metals are then lifted off by removing the resist mask and the laser light incidence port 29 is formed (FIG. 6C).

Irradiation with UV radiation of predetermined energy is then performed from the rear surface side of the support substrate 40, and the adhesive sheet 42 is peeled off together with the support substrate 40 (FIG. 6D). The wavelength converting member 20a is produced by the above-described steps.

With the wavelength converting member 20a according to the second embodiment and the light source device 2 using the wavelength converting member 20a, it is possible to obtain the effects and advantages similar to those obtained in the first embodiment. As such, the light extraction efficiency and safety to the eyes are further improved.

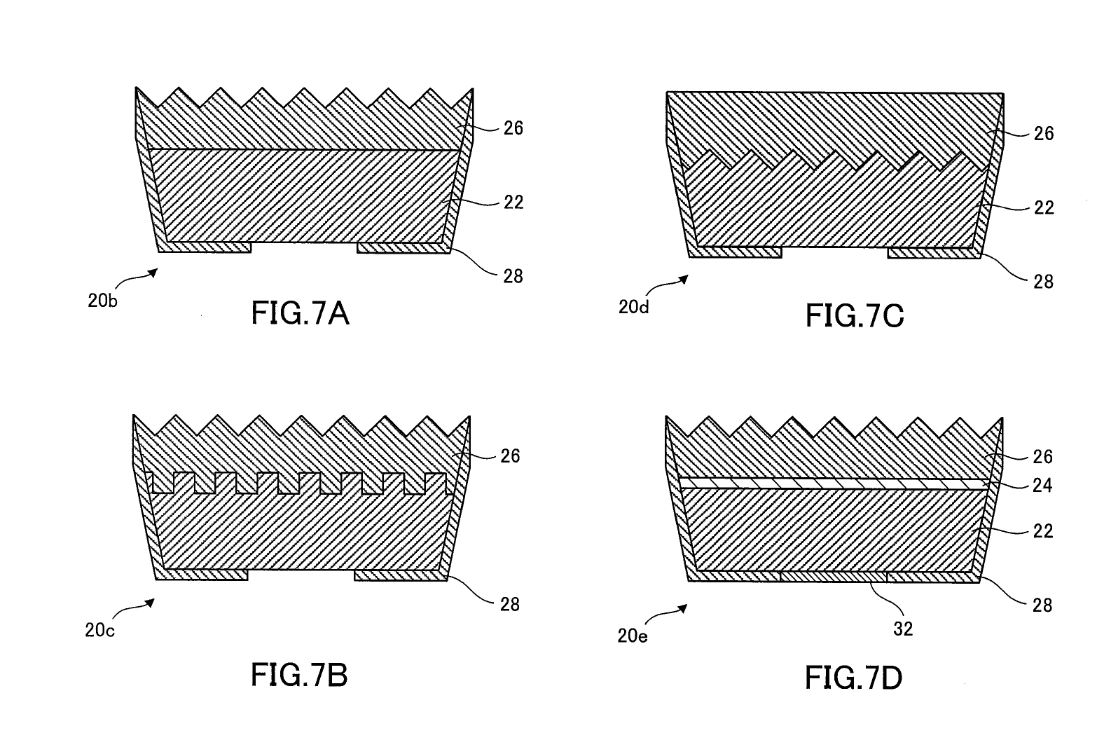

FIGS. 7A to 7D illustrate modifications to the wavelength converting member 20a, respectively.

In the wavelength converting member 20b shown in FIG. 7A, the phosphor layer 22 made from phosphor glass and the high-refractive layer 26 made from a nitride semiconductor are bonded together directly without using the adhesive layer. As a result, the heat generated in the phosphor layer 22 is readily transferred to the high-refractive layer 26 and heat dissipation ability is improved. Such laminated structure can be obtained for example in the following manner. After the crystal growth of the nitride semiconductor constituting the high-refractive layer 26 has been performed, a starting material for phosphor glass is scattered or disseminated over the nitride semiconductor surface, melted at a temperature of about 950° C. (degrees C.) and then solidified. As shown in FIG. 4C, the sapphire substrate 30 is peeled off, and concaves are formed by wet etching on the surface of the nitride semiconductor that has thus been exposed, as shown in FIG. 4D. Then, the support substrate 40 is attached by using the adhesive sheet 42 as shown in FIGS. 6A to 6D, the nitride semiconductor is divided, and the light reflecting film 28 is provided. The wavelength converting member 20b is similar to the wavelength converting member 20a in that it has the light reflecting film 28 that covers the side surface thereof and part of the laser light incidence surface.

In a wavelength converting member 20c shown in FIG. 7B, the high-refractive layer 26 has concaves both on the bonding surface where the high-refractive layer is bonded to the phosphor layer 22 and on the light extraction surface. The phosphor layer 22 is brought into intimate contact and bonded to the concave surface of the high-refractive layer 26. By forming the light scattering -diffraction structure on both surfaces of the high-refractive layer 26, it is possible to enhance the diffraction and scattering of the laser light. Since the contact surface area between the phosphor layer 22 and the high-refractive layer 26 is increased, heat dissipation ability can be further enhanced. For example, where the crystal growth of the nitride semiconductor of the high-refractive layer 26 takes place, the peaks and valleys (or concaves) are formed on the nitride semiconductor surface by dry etching, the starting material of phosphor glass is scattered over the peak-valley surface, melted at a temperature of about 950° C., and brought into intimate contact with the peak-valley portion, then it is possible to obtain a peak-valley bonding surface between the phosphor layer 22 and the high-refractive layer 26. The shape and dimensions of the peaks and valleys may be determined in a manner to obtain desired light scattering and diffraction effects. For example, the peak-valley surface can be constituted by stripe-like grooves. Peaks and valleys on the light extraction surface side can be formed by wet etching performed in the same manner as in the first embodiment after the sapphire substrate has been peeled off. The support substrate 40 is then attached by using the adhesive sheet 42 as shown in FIGS. 6A to 6D, the nitride semiconductor is divided, and the light reflecting film 28 is provided. The wavelength converting member 20c is similar to the wavelength converting member 20a in that it has the light reflecting film 28 that covers the side surface thereof and part of the laser light incidence surface.

In a wavelength converting member 20d shown in FIG. 7C, the high-refractive layer 26 has hexagonal pyramidal protrusions (microcones) on the bonding surface where the high-reflective layer is in contact with (or bonded to) the phosphor layer 22. The phosphor layer 22 is brought into intimate contact and attached to the peak-valley surfaces. Thus, the wavelength converting member 20d has a light scattering-diffraction structure on the interfaces (or contact surfaces) between the high-refractive layer 26 and the phosphor layer 22. With such configuration, it is also possible to obtain the light scattering-diffraction effect similar to that obtained with the wavelength converting members of the above-described embodiments. Further, since the contact surface area between the phosphor layer 22 and the high-refractive layer 26 is increased, heat dissipation ability can be further enhanced. It should be noted that the light extraction surface of the high-refractive index 26 may be flat as shown in FIG. 7C or may be concave.

Such laminated structure can be obtained in the following manner. The support substrate is attached to the nitride semiconductor surface after the crystal growth of the nitride semiconductor constituting the high-refractive layer 26 on the sapphire substrate takes place. Then, the sapphire substrate is peeled off by the laser lift-off method or the like. Hexagonal pyramidal protrusions (microcones) are formed by wet etching on the surface (C-surface) of the nitride semiconductor that has been exposed by peeling off the sapphire substrate. A starting material of phosphor glass is scattered over the nitride semiconductor surface where the hexagonal pyramidal protrusions have been formed, melted at a temperature of about 950° C. and brought into intimate contact with the peak-valley surface, followed by solidification. The nitride semiconductor is then divided, the light reflecting film 28 is formed, and the support substrate is then removed. The wavelength converting member 20d is similar to the wavelength converting member 20a in having the light reflecting film 28 that covers the side surface thereof and part of the laser light incidence surface.

In a wavelength converting member 20e shown in FIG. 7D, the laser light incidence port is covered with an antireflective film (AR film) 32. The antireflective film 32 is a multilayer film obtained, for example, by alternate repeated lamination of layers of two types that differ from each other in a refractive index. Examples of materials for the high(er)-refractive layer include TiO₂ and Ta₂O₅. For example, SiO₂ can be used as a material for the low(er)-refractive layer. The antireflective film 32 is formed by alternately laminating the high-refractive layers and low-refractive layers made from such materials. A medium-refractive layer having a refractive index between those of the high-refractive layer and the low-refractive layer may be inserted between these two layers. For example, Al₂O₃ can be used as a material for the medium-refractive layer.

By providing the antireflective film 32 at the laser light incidence port of the phosphor layer 22, it is possible to reduce light reflection at the laser light incidence surface and increase the efficiency of laser light introduction into the wavelength converting member 20e.

This application is based on Japanese Patent Application No. 2011-45309 filed on Mar. 2, 2011, and the entire disclosure thereof is incorporated herein by reference.

What is claimed is:

1. A wavelength converting member into which laser light is introduced and which radiates light having a wavelength different from a wavelength of the laser light, the wavelength converting member comprising:
a phosphor layer that contains a phosphor therein and has a laser light incidence surface capable of receiving the laser light; and
a high-refractive layer that is bonded to an opposite surface of the phosphor layer to the laser light incidence surface thereof, the high-refractive layer having a refractive index higher than a refractive index of the phosphor layer, the high-refractive layer having concaves on at least either a bonding surface where the high-refractive layer is bonded to the phosphor layer or a light extraction surface that is opposite the bonding surface.

2. The wavelength converting member according to claim 1 further comprising a light reflecting film that partially covers the phosphor layer and an exposed surface of the high-refractive layer.

3. The wavelength converting member according to claim 1, wherein the high-refractive layer includes a nitride semiconductor or a phosphide semiconductor.

4. The wavelength converting member according to claim 3, wherein the nitride semiconductor is a gallium nitride semiconductor.

5. The wavelength converting member according to claim 3, wherein the concaves include pyramidal protrusions derived from a crystal structure of the nitride semiconductor or the phosphide semiconductor.

6. The wavelength converting member according to claim 1, wherein the phosphor layer is made from phosphor glass or phosphor ceramic.

7. The wavelength converting member according to claim 1, wherein the high-refractive layer has the concaves on both the light extraction surface and the bonding surface of the phosphor layer.

8. The wavelength converting member according to claim 1 further comprising an antireflective film provided on the laser light incidence surface of the phosphor layer.

9. The wavelength converting member according to claim 1 further comprising an adhesive layer interposed between the phosphor layer and the high-refractive layer.

10. The wavelength converting member according to claim 9, wherein the adhesive layer includes an SOG (spin on glass).

11. The wavelength converting member according to claim 1, wherein the light extraction surface of the high-refractive layer is a light scattering and diffraction surface.

12. The wavelength converting member according to claim 1, wherein a refractive difference between the high-refractive layer and air is one or more.

13. The wavelength converting member according to claim 1, wherein the concaves include microcones.

14. The wavelength converting member according to claim 1, wherein a thermal conductivity of the high-refractive layer is between 150 W/mk and 250 W/mK.

15. The wavelength converting member according to claim 8, wherein the antireflective film is a multilayer film that includes a plurality of layers having different refractive indices.

16. The wavelength converting member according to claim 15, wherein the multilayer film includes a first type of layers and a second type of layers laminated alternately, and the first type of layer has a higher refractive index than the second type of layer.

17. A light source device having the wavelength converting member according to claim 1, the light source device further comprising a semiconductor laser that irradiates the laser light incidence surface with laser light.

18. The light source device according to claim 17, wherein a diameter and a height of each protrusion of the concaves are not more than 10 times a wavelength of the laser light inside the high-refractive layer.

19. The light source device according to claim 17, wherein the semiconductor laser includes a GaN semiconductor layer to emit a blue light.

20. The light source device according to claim 17 further comprising an optical system provided between the semiconductor laser and the wavelength converting member.
